(19) United States
(12) Patent Application Publication
(10) Pub. No.: US 2003/0197977 A1
(43) Pub. Date: Oct. 23, 2003

(54) Recording medium cartridge

(75) Inventors: Harumi Aoishi, Odawara-shi (JP); Fumihito Imai, Odawara-shi (JP); Hideaki Shiga, Odawara-shi (JP); Akihisa Kusayanagi, Odawara-shi (JP); Kiyoo Morita, Odawara-shi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/419,115

(22) Filed: Apr. 21, 2003

(30) Foreign Application Priority Data
Apr. 19, 2002 (JP) 117838/2002
May 7, 2002 (JP) 131136/2002
May 21, 2002 (JP) 145664/2002

(51) Int. Cl. G11B 23/03

(52) U.S. Cl. 360/133

(57) ABSTRACT

A recording medium cartridge comprising a housing that accommodates a recording medium. By accommodating a different recording medium with a different recording capacity within the housing of approximately the same shape, recording medium cartridges of different generations can be constituted. An external surface of the housing is provided with an identification part, which differs in shape from generation to generation, for discriminating between the different generations.

### BACKGROUND OF THE INVENTION

1. Field of the Invention

The present invention relates to recording medium cartridges in which a recording medium such as a disk medium is rotatably accommodated within the housing.

2. Description of the Related Art

With the rapid spread of electronic equipment such as audio equipment, digital cameras, digital video cameras, personal computers, etc., a broad variety of recording media have been developed and put to practical use. From the standpoint of portability, convenience, economy, etc., the realization of an inexpensive small recording medium with a large recording capacity has been desired.

Recording media that are in current use include many different types such as semiconductor memory types, floppy disk types, hard disk types, magnetic tape types, magneto-optical (MO) disk types, etc. Recording medium cartridges with a magnetic disk medium or tape medium are now in wide use, because the recording capacity is large for their size and also the cost is relatively low. Examples of cartridges with a magnetic disk medium include floppy disks, minidisk (MD) cartridges, MO cartridges, “clik!™”, etc. Examples of cartridges with a magnetic tape medium include audio cassettes, DAT tapes, VHS tapes, etc.

In the above-described recording medium cartridges, incidentally, an increase in the recording capacity has always been demanded. A large recording capacity can be achieved by an enhancement in recording line density, an enhancement in track density, an increase in a recording area, etc.

If a cartridge with a recording medium larger in recording capacity than a conventional one is developed, a new recording-reproducing drive with a mechanism for driving that large-capacity type will be developed. However, in data recording-reproducing systems, making use of recorded data is vital, and every time a system is upgraded, upward compatibility (ability of a newer recording-reproducing unit for a newer or larger cartridge to accept an older or smaller cartridge) is strongly demanded.

If the housing of a newer recording medium cartridge is made approximately the same as that of an older recording medium cartridge, the capacity of a recording medium for the newer cartridge is made larger, and a cartridge drive for the newer cartridge corresponding to that large recording capacity is made so it can perform recording and reproducing operations on both a large-capacity recording medium and a small-capacity recording medium, then there is no need to change the arrangement and mechanism of the cartridge housing and read-write unit accommodated within the cartridge drive, and therefore it is possible to have upward compatibility relatively easily.

However, when the housing of a newer recording medium cartridge is approximately the same as that of an older recording medium cartridge, it becomes difficult for a user to visually discriminate between the two cartridges, so the problem of a reduction in marketability will arise.

In addition, because of the resemblance in outer appearances, there is also a possibility that a user will incorrectly insert a newer recording medium cartridge into an older cartridge drive that does not correspond to the newer cartridge. When each generation does not have upward compatibility, there is a possibility that an older recording medium cartridge will be inserted incorrectly into a drive for a newer recording medium cartridge.

### SUMMARY OF THE INVENTION

The present invention has been made in view of the circumstances mentioned above. Accordingly, it is a first object of the present invention to provide a recording medium cartridge which can be constructed as recording medium cartridges of different generations having a housing of approximately the same shape and which can easily be discriminated among different generations.

A second object of the present invention is to provide a recording medium cartridge that is capable of preventing incorrect insertion into an incompatible cartridge drive, while achieving the first object of the present invention.

To achieve the above-described objects and in accordance with the present invention, there is provided a first recording medium cartridge comprising a housing that accommodates a recording medium. In the first cartridge, recording medium cartridges of different generations can be constituted by accommodating a different recording medium with a different recording capacity within the housing of approximately the same shape. An external surface of the housing of the first cartridge has an identification part, which differs in shape from generation to generation, for discriminating between the different generations.

In accordance with the present invention, there is provided a second recording medium cartridge comprising a discoid medium fixedly attached to a center hub. The second cartridge further comprises a housing that accommodates the disk medium. In the second cartridge, recording medium cartridges of different generations can be constituted by accommodating different disk mediums with different recording capacities within the housing of approximately the same shape. An external surface of the housing of the second cartridge has an identification part, which differs in shape from generation to generation, for discriminating between the different generations.

In accordance with the present invention, there is provided a third recording medium cartridge comprising a magnetic flexible disk fixedly attached to a center hub. The third cartridge further comprises a housing in which the disk medium is accommodated and which has a hole, and a shutter slidable so that a magnetic head is positioned over a surface of the magnetic disk through the hole. In the third cartridge, recording medium cartridges of different generations can be constituted by accommodating different magnetic disks with different recording capacities within the housing of approximately the same shape. An external surface of the housing of the third cartridge has an identification part, which differs in shape from generation to generation, for discriminating between the different generations.

According to the recording medium cartridges of the present invention, an external surface of the housing is provided with an identification part that differs in shape from generation to generation, so visual discrimination between different generations can be facilitated. By providing such an identification part, it is also possible to prevent incorrect insertion into an incompatible cartridge drive that does not have a member (or a part) engageable with that identification part.

### BRIEF DESCRIPTION OF THE DRAWINGS

The present invention will be described in further detail with reference to the accompanying drawings wherein:

FIGS. 1A to 1F are front, rear, right side, left side, plan, and bottom views showing a “clik!™ (cartridge)” to which the present invention is applied;

FIG. 2 is a plan view showing a recording medium cartridge constructed in accordance with a first embodiment of the present invention;

FIG. 3 is a plan view showing a recording medium cartridge constructed in accordance with a second embodiment of the present invention;

FIGS. 4A to 4D are part-plan views showing recording medium cartridges constructed in accordance with third to sixth embodiments of the present invention, respectively;

FIGS. 5A and 5B are part-plan views showing recording medium cartridges constructed in accordance with seventh and eighth embodiments of the present invention, respectively;

FIGS. 6A to 6F are front views showing recording medium cartridges constructed in accordance with ninth to fourteenth embodiments of the present invention, respectively;

FIG. 7 is a plan view showing a recording medium cartridge constructed in accordance with a fifteenth embodiment of the present invention;

FIG. 8 is a plan view showing a recording medium cartridge constructed in accordance with a sixteenth embodiment of the present invention;

FIG. 9 is a plan view showing a recording medium cartridge constructed in accordance with a seventeenth embodiment of the present invention;

FIGS. 10A and 10B are plan and left side views showing a recording medium cartridge constructed in accordance with an eighteenth embodiment of the present invention;

FIGS. 11A and 11B are sectional views showing a recording medium cartridge constructed in accordance with a nineteenth embodiment of the present invention;

FIG. 12 is a plan view showing a recording medium cartridge constructed in accordance with a twentieth embodiment of the present invention;

FIG. 13 is a plan view showing a recording medium cartridge constructed in accordance with a twenty-first embodiment of the present invention;

FIG. 14A is a perspective view showing one variation of the recording medium cartridge constructed in accordance with the twenty-first embodiment of the present invention;

FIG. 14B is a perspective view showing another variation of the recording medium cartridge constructed in accordance with the twenty-first embodiment;

FIG. 15 is a plan view showing a recording medium cartridge constructed in accordance with a twenty-second embodiment of the present invention;

FIG. 16 is a plan view showing a recording medium cartridge constructed in accordance with a twenty-third embodiment of the present invention;

FIG. 17 is a plan view showing a recording medium cartridge constructed in accordance with a twenty-fourth embodiment of the present invention;

FIGS. 18A to 18D are part-plan views showing other variations of the recording medium cartridge constructed in accordance with the twenty-fourth embodiment of the present invention, respectively;

FIG. 19 is a plan view showing a recording medium cartridge constructed in accordance with a twenty-fifth embodiment of the present invention;

FIGS. 20A and 20B are plan and right side views showing the recording medium cartridge constructed in accordance with the twenty-fifth embodiment of the present invention;

FIG. 21 is a bottom view showing a recording medium cartridge constructed in accordance with a twenty-sixth embodiment of the present invention;

FIG. 22 is a bottom view showing a variation of the recording medium cartridge constructed in accordance with the twenty-sixth embodiment;

FIG. 23 is a front view showing a recording medium cartridge constructed in accordance with a twenty-seventh embodiment of the present invention;

FIGS. 24A and 24B are right side and bottom views showing a recording medium cartridge constructed in accordance with the twenty-eighth embodiment of the present invention;

FIG. 25 is a bottom view showing a recording medium cartridge constructed in accordance with a twenty-ninth embodiment of the present invention;

FIGS. 26A and 26B are plan views showing an MD cartridge in current use,

FIG. 27 is a plan view showing a recording medium cartridge constructed in accordance with a thirtieth embodiment of the present invention;

FIGS. 28A and 28B are plan views showing a recording medium cartridge constructed in accordance with a thirty-first embodiment of the present invention;

FIG. 29 is a perspective view showing a cartridge in current use;

FIGS. 30A and 30B are plan views showing a recording medium cartridge constructed in accordance with a thirty-second embodiment of the present invention;

FIGS. 31A and 31B are plan views showing a recording medium cartridge constructed in accordance with a thirty-third embodiment of the present invention; and

FIGS. 32A and 32B are plan views showing a recording medium cartridge constructed in accordance with a thirty-fourth embodiment of the present invention.

### DESCRIPTION OF THE PREFERRED EMBODIMENTS

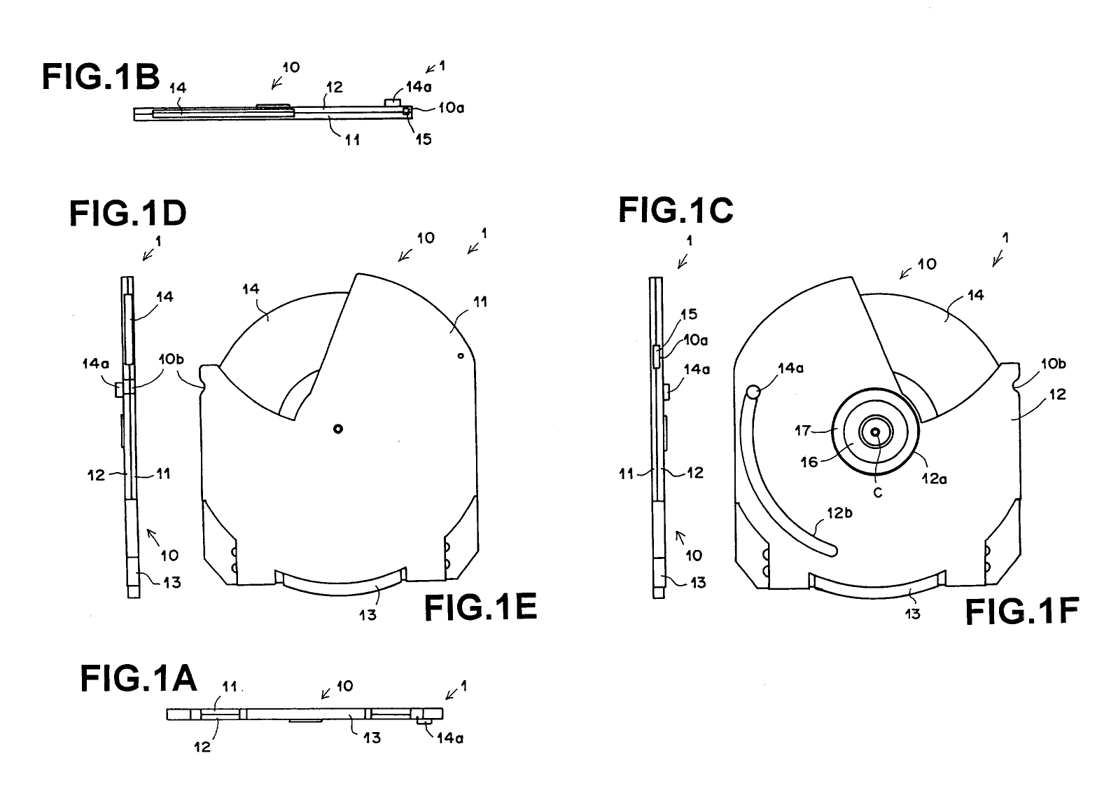

Embodiments of the present invention will hereinafter be described with reference to the drawings. In the first embodiment to the twenty-ninth embodiment, the present invention is applied to a “clik!™”, which is a recording medium cartridge with a disk medium in current use. Initially, a description is given of the current clik!™ (existing cartridge) shown in FIG. 1.

In the figure, the existing cartridge 1 includes a housing 10, which comprises an upper metal shell half 11, a lower metal shell half 12, a resin part 13, a shutter 14 with a shutter knob 14a mounted thereon, a shutter lock 15 for locking the shutter 14 at a shutter closing position, and an urging member (not shown) for urging the shutter 14 toward the shutter closing position. The resin part 13, the shutter 14, and the shutter lock 15 are disposed between the upper and lower metal shell halves 11 and 12. In the interior of the housing 10, a magnetic disk 17 fixedly attached on a center hub 16 is rotatably accommodated. The right side surface of the housing 10 is provided with a shutter slot 10a, through which part of the shutter lock 15 is exposed. The left side surface of the housing 10 is provided with a positioning notch 10b, which is engaged by the engagement member of a cartridge drive (not shown) for the existing cartridge 1 to ensure the positioning of the existing cartridge 1 when it is inserted into the existing cartridge drive.

The lower metal shell half 12 is provided with a spindle hole 12a into which a spindle in the cartridge drive is inserted, and a shutter-knob slot 12b along which the shutter knob 14a is movable.

When the existing cartridge 1 is inserted into or removed out of the cartridge drive (not shown), the shutter 14 is automatically opened or closed in the following manner.

If the existing cartridge 1 is inserted into the cartridge drive (not shown), a press member in the cartridge drive is first pressed against the shutter lock 15 exposed through the shutter slot 10a. Therefore, the shutter 14 is released from the shutter lock 15 and becomes movable. Then, the shutter knob 14a mounted on the shutter 14 is held by a lock member within the cartridge drive. If the existing cartridge 1 is further inserted into the cartridge drive, the shutter knob 14b held by the lock member of the cartridge drive is moved downward with respect to the center C of the housing 10 shown in FIG. 1F. This causes the shutter knob 14b to rotate to a shutter opening position in the counterclockwise direction with respect to the center C of the housing 10, and the magnetic disk 17 is exposed.

In removing the existing cartridge 1 from the cartridge drive (not shown), the shutter 14 is urged toward the shutter closing position by the urging member (not shown), so the shutter 14 is moved to the shutter closing position in the reversed procedure.

When, based on the existing cartridge 1, a new generation of recording medium cartridge is made by forming a magnetic disk increased in recording capacity than the magnetic disk 17 through an enhancement in recording density and then accommodating the recording-capacity increased disk in a housing of approximately the same shape as the housing 10 of the existing cartridge 1, it is easy to cause the existing cartridge 1 to correspond to a cartridge drive for the new generation cartridge, but there is a possibility that the discrimination in outer appearances between the existing cartridge 1 and the new generation cartridge will become difficult. There is also a possibility that the new generation cartridge will be inserted incorrectly into a cartridge drive that does not correspond to the new generation cartridge.

Hence, in accordance with the present invention, the exterior surface of a recording medium cartridge is provided with an identification part that differs in shape from generation to generation. This facilitates the visual discrimination between different generations, and also prevents incorrect insertion into an incompatible cartridge drive.

As an example of such an identification part, the exterior surface of the housing 10 may be provided with a protrusion or recess. Recording medium cartridges, constructed in accordance with the first to the fifteenth embodiments of the present invention, are equipped with such an identification part.

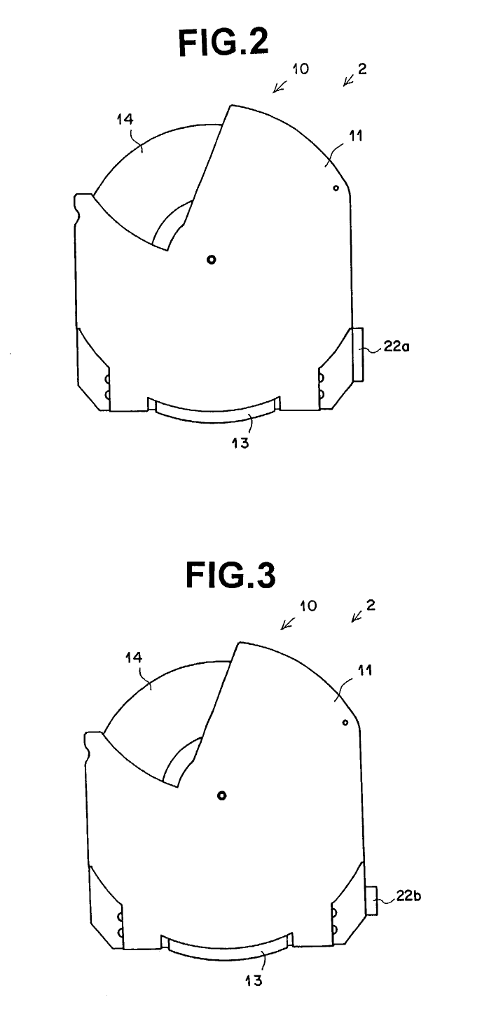

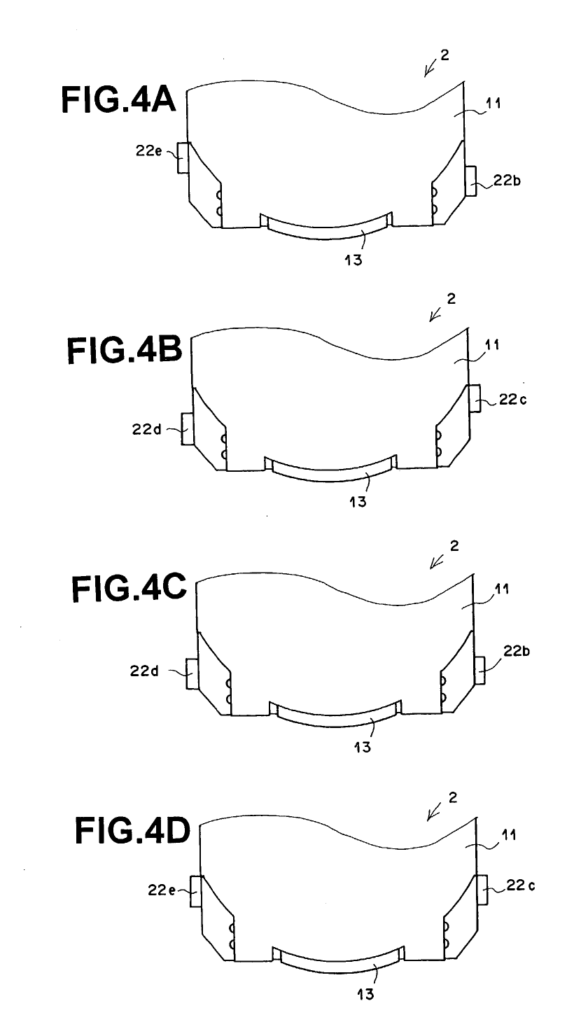

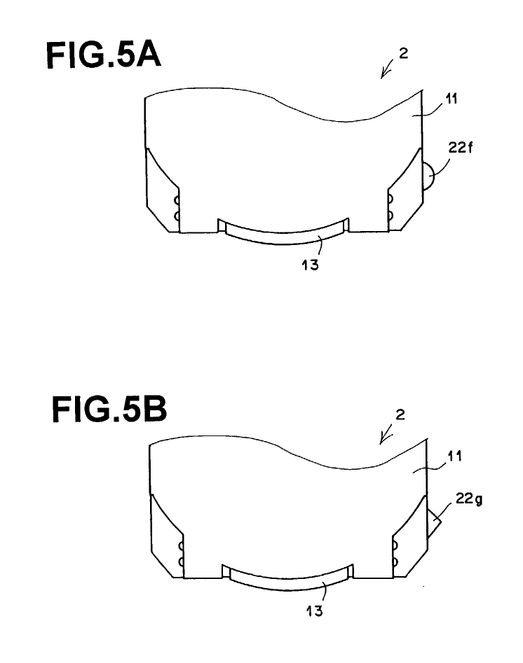

In the case where the side surface of the housing 10 is provided with the above-described identification part (protrusions or recesses), a right side protrusion 22a may be provided on the entire right surface of the resin part 13, as shown in FIG. 2 as the first embodiment of the present invention. As shown in FIG. 3 as the second embodiment of the present invention, a right side protrusion 22b may be provided only on the lower half of the right side surface of a housing 10. Of course it may be provided only on the upper half. In addition, both side surfaces of the resin part 13 may be provided with protrusions, respectively. As shown in FIG. 4A as the third embodiment of the present invention, a right side protrusion 22b may be provided only on the lower half of the right side surface of a resin part 13, and a left side protrusion 22e may be provided only on the upper half of the left side surface of the resin part 13. As shown in FIG. 4B as the fourth embodiment of the present invention, a right side protrusion 22c may be provided only on the upper half of the right side surface of a resin part 13, and a left side protrusion 22d may be provided only on the lower half of the left side surface of the resin part 13. As shown in FIG. 4C as the fifth embodiment of the present invention, a right side protrusion 22b and a left side protrusion 22d may be provided only on the lower halves of the left and right side surfaces of a resin part 13. As shown in FIG. 4D as the sixth embodiment of the present invention, a right side protrusion 22c and a left side protrusion 22e may be provided only on the upper halves of the left and right side surfaces of a resin part 13. Furthermore, as shown in FIG. 5A as the seventh embodiment of the present invention, a protrusion 22f semicircular in cross-section may be provided on the right side surface of a resin part 13. As shown in FIG. 5B as the eighth embodiment of the present invention, a protrusion 22g triangular in cross-section may be provided on the right side surface of a resin part 13. While only examples of protrusions have been shown, recesses can also be provided in the same manner. Protrusions (or recesses) that are provided on side surfaces are not to be limited to the above-described positions, numbers, and shapes. That is, many variations are possible.

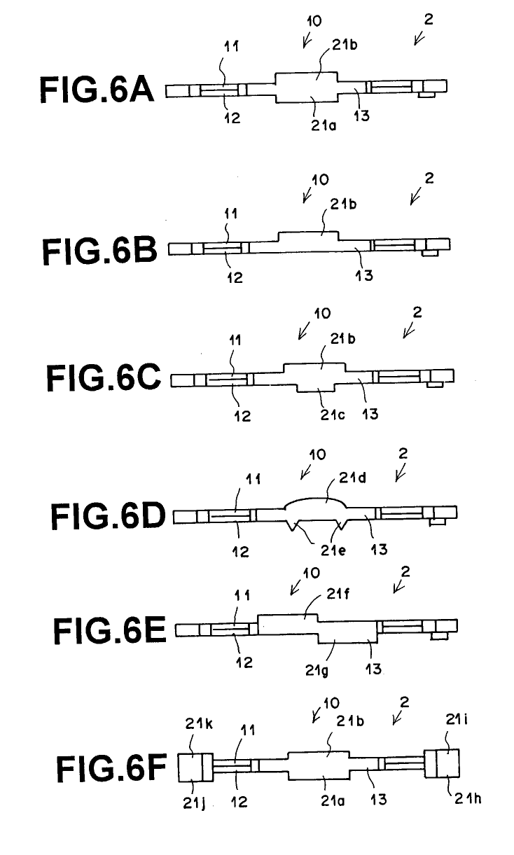

In the case where the top and bottom surfaces of the housing 10 are provided with the above-described identification part (protrusions or recesses), an upper protrusion 21b, as well as a lower protrusion 21a normally provided on the bottom surface of the pushing portion (near to the center) of a resin part 13, may be provided on the top surface, as shown in FIG. 6A as the ninth embodiment of the present invention. As shown in FIG. 6B as the tenth embodiment of the present invention, an upper protrusion 21b may be provided on only the top surface. As shown in FIG. 6C as the eleventh embodiment of the present invention, a lower protrusion 21c, narrower in width than the protrusion 21a normally provided, may be provided on the bottom surface, and an upper protrusion 21b may be provided on the top surface. As shown in FIG. 6D as the twelfth embodiment of the present invention, a lower protrusion 21ewith a triangular cross-section may be provided on the bottom surface, and an upper protrusion 21d with an arcuate cross-section may be provided on the top surface. As shown in FIG. 6E as the thirteenth embodiment of the present invention, a lower protrusion 21g may be provided on only the right half of the bottom surface, and an upper protrusion 21f may be provided on only the left half of the top surface. As shown in FIG. 6F as the fourteenth embodiment of the present invention, upper and lower protrusions 21b and 21a may be provided on the pushing portion (near the center), and in addition, protrusions 21h, 21i, 21j, and 21k may be provided near the side surfaces. While only examples of protrusions have been shown, recesses can also be provided within the thickness of the housing in the same manner. The protrusions (or recesses) that are provided on the top and bottom surfaces are not to be limited to the above-described positions, numbers, and shapes. That is, many variations are possible.

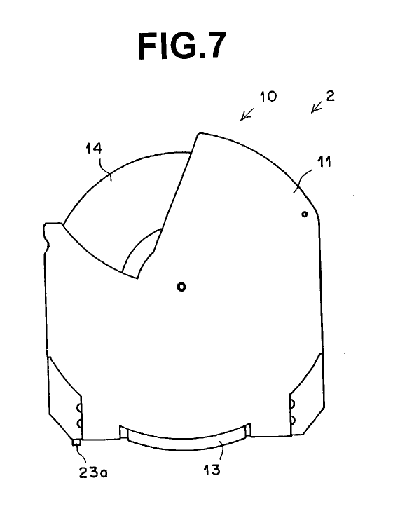

In the case where the front surface of the housing 10 is provided with the above-described identification part (protrusion or recess), a front protrusion 23a may be provided near the left end of a resin part 13, as shown in FIG. 7 as the fifteenth embodiment of the present invention. Although only the protrusion is used in this embodiment, it is possible to provide a recess in the same manner. A protrusion (or a recess) that is provided on the front surface is not to be limited to the above-described position, number, and shape. That is, many variations are possible.

As set forth above, the side surfaces, top and bottom surfaces, and front surface of the housing 10 are provided with protrusions (or recesses). This makes it possible to visually discriminate between the existing cartridge 1 and the new generation cartridge 2.

In addition, by providing such protrusions (or recesses), insertion into an incompatible cartridge drive (such as a cartridge drive for the existing cartridge 1 in which the cartridge inserting part does not correspond to the external shape of the new generation cartridge 2) becomes physically impossible, so it is also possible to prevent incorrect insertion into such an incompatible cartridge drive.

In the embodiments described above, while protrusions (or recesses) have been provided on the side surfaces, top and bottom surfaces, or front surface of the housing, they may be employed in an arbitrary combination of the side surfaces, the top and bottom surfaces, and the front surface.

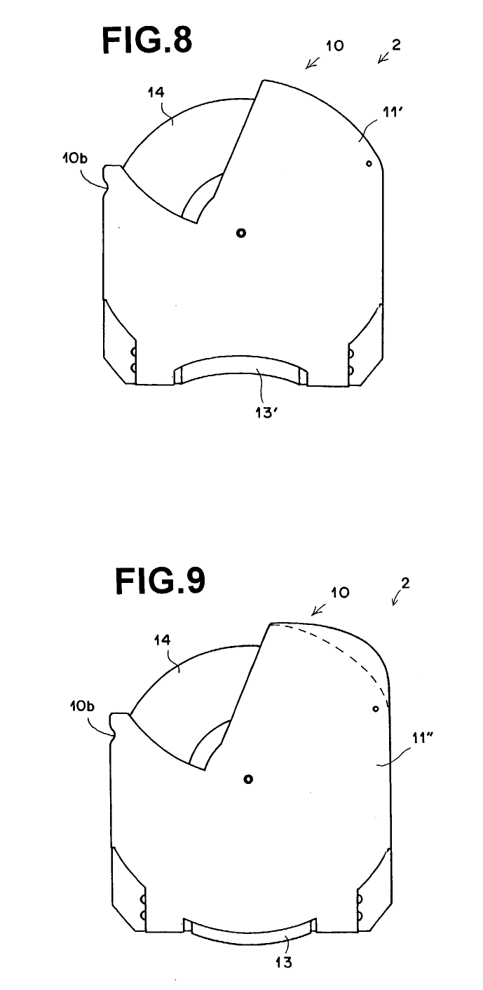

Next, a description will be given of a sixteenth embodiment of the present invention. The identification part in the present invention may be the pushing part (resin part) of a recording medium cartridge that differs in shape from that of the existing cartridge 1. A recording medium cartridge 2 according to this embodiment is equipped with such an identification part, and is shown in FIG. 8.

While the pushing part 13 of the existing cartridge 1 projects out from the lower edge, the pushing part 13′ of the recording medium cartridge 2 shown in FIG. 8 is indented inside from the lower edge. Since the shape of the resin part 13′ is changed, the shape of upper and lower shell halves 11′ and 12′ is also changed from those of the existing cartridge 1. This makes it possible to visually discriminate between the existing cartridge 1 and the new generation cartridge 2.

In addition, by denting the pushing part 13′, a distance that the new generation cartridge 2 moves during insertion becomes shorter. Because of this, insertion into an incompatible cartridge drive (such as a cartridge drive for the existing cartridge 1 that requires a distance longer than a distance that the new generation cartridge 2 moves during insertion) becomes physically impossible. Therefore, it is also possible to prevent incorrect insertion into such an incompatible cartridge drive.

Furthermore, by denting the pushing portion 13′, stability at the time of the insertion into a cartridge drive can be enhanced.

Next, a description will be given of a seventeenth embodiment of the present invention. The identification part in the present invention may be a front corner in the insertion direction of a recording medium cartridge that differs in shape from that of the existing cartridge 1. A recording medium cartridge 2 according to this embodiment is equipped with such an identification part, and is shown in FIG. 9.

In the figure, the right corner in the insertion direction of the housing 10 of the recording medium cartridge 2 bulges outside, compared with the right corner (indicated by a broken line) of the existing cartridge 1. This makes it possible to visually discriminate between the existing cartridge 1 and the new generation cartridge 2.

In addition, by deforming the front corner of the recording medium cartridge 2, insertion into an incompatible cartridge drive (such as a cartridge drive for the existing cartridge 1 in which the cartridge inserting part does not correspond to the external shape of the new generation cartridge 2) becomes physically impossible, so it is also possible to prevent incorrect insertion into such an incompatible cartridge drive.

Note that the corner in the embodiment shown in FIG. 9 may have any shape if it is different from that of the existing cartridge 1. For instance, it may be a right-angled corner, or the shape of the left corner may be changed.

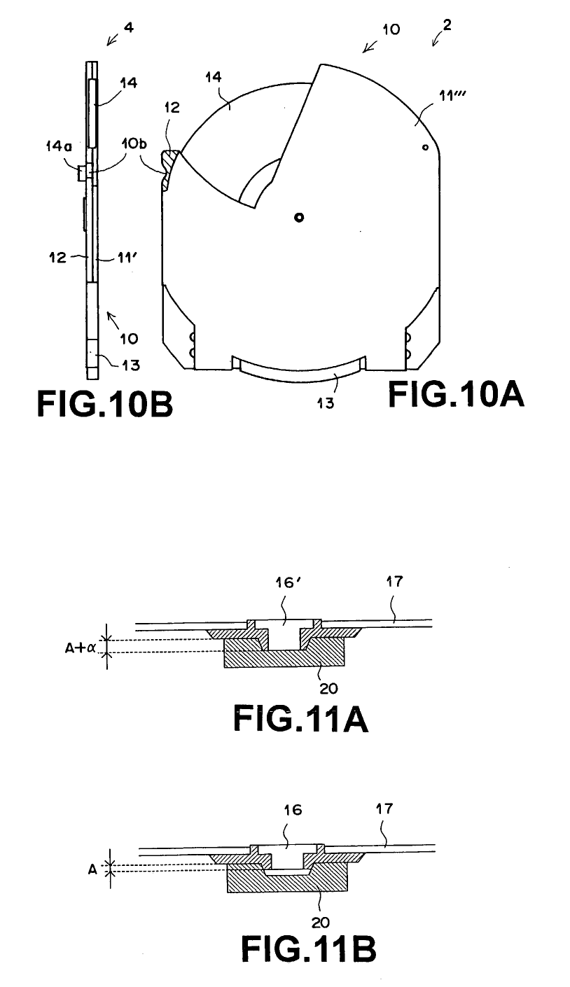

Next, a description will be given of an eighteenth embodiment of the present invention. The identification part in the present invention may be a step portion, which is provided in the outer circumferential portion of a recording medium cartridge in the thickness direction (width direction of the cartridge in FIG. 10). A recording medium cartridge 2 according to this embodiment is equipped with such an identification part, and is shown in FIGS. 10A and 10B.

In FIG. 10A, the left corner in the insertion direction of the housing 10 of the recording medium cartridge 2 is provided with a step portion (shaded portion). This makes it possible to visually discriminate between the existing cartridge 1 and the new generation cartridge 2.

In addition, by providing the step portion in the outer circumferential portion of the recording medium cartridge 2 in the thickness direction, insertion into an incompatible cartridge drive (such as a cartridge drive for the existing cartridge 1 in which the cartridge inserting part does not correspond to the external shape of the new generation cartridge 2) becomes physically impossible, so it is also possible to prevent incorrect insertion into such an incompatible cartridge drive.

Note that the position and height of the step portion are not to be limited to the embodiment shown in FIGS. 10A and 10B. That is, many variations are possible.

Next, a description will be given of a nineteenth embodiment of the present invention. The identification part in the present invention may be a center hub that differs in shape from that of the existing cartridge 1. A recording medium cartridge 2 according to this embodiment is equipped with such an identification part, and is shown in FIGS. 11A and 11B.

As shown in the figures, the center hub 16′ of the recording medium cartridge 2 in this embodiment has approximately the same shape as the center hub 16 of the existing cartridge 1, but only the height of the engagement portion of the center hub 16′ which fits in the spindle 20 of a cartridge drive differs from that of the existing cartridge 1. Note that the diameter and taper of the engagement portion are the same. This makes it possible to visually discriminate between the existing cartridge 1 and the new generation cartridge 2.

In addition, by differentiating the height of the engagement portion from that of the existing cartridge 1, insertion into an incompatible cartridge drive (such as a cartridge drive for the existing cartridge 1 in which the spindle does not correspond to the shape of the center hub of the new generation cartridge 2) becomes physically impossible, so it is also possible to prevent incorrect insertion into such an incompatible cartridge drive. As shown in FIG. 11B, it is possible to insert the existing cartridge 1 into a cartridge drive that corresponds to the recording medium cartridge of this embodiment, but since the height of the engagement portion of the center hub 16 of the existing cartridge 1 is smaller than the depth of the engagement portion of the spindle 20 of that cartridge drive, they cannot engage each other correctly.

Note that the shape of the center hub 16′ is not to be limited to the embodiment shown in FIG. 11A. That is, many variations are possible.

Next, a description will be given of a twentieth embodiment of the present invention. The identification part in the present invention may be a protrusion, which is provided on the left shoulder portion of the existing cartridge 1. A recording medium cartridge 2 according to this embodiment is equipped with such an identification part, and is shown in FIG. 12.

The left shoulder portion of the recording medium cartridge 2 is provided with a protrusion 10c, which is higher than the shoulder portion (indicated by a broken line) of the existing cartridge 1. This makes it possible to visually discriminate between the existing cartridge 1 and the new generation cartridge 2.

The left shoulder portion of the new generation cartridge 2 becomes higher than that of the existing cartridge 1. Therefore, when the new generation cartridge 2 is inserted into a drive for the existing cartridge 1, the left shoulder portion interferes with that cartridge drive and therefore the insertion of the new generation cartridge 2 becomes physically impossible. Thus, it becomes possible to prevent incorrect insertion into an incompatible cartridge drive.

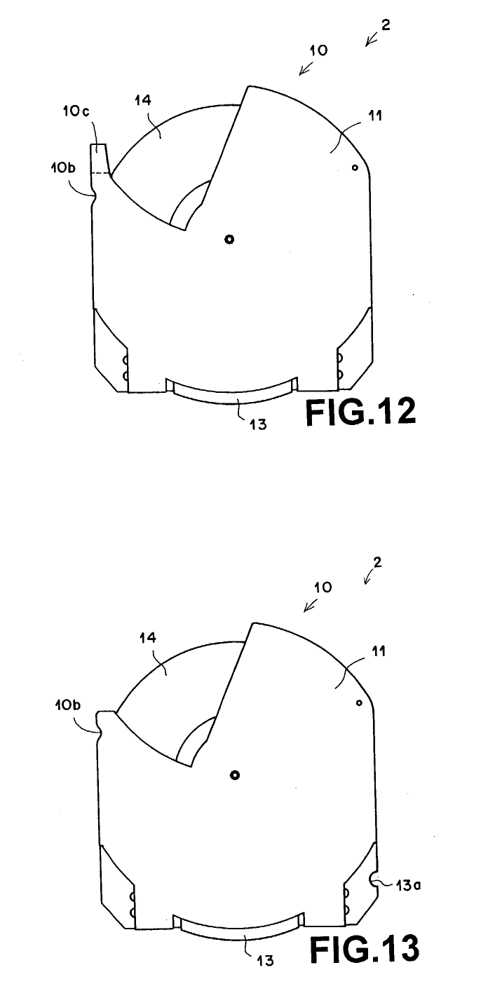

Next, a description will be given of a twenty-first embodiment of the present invention. The identification part in the present invention may be a recess, which is provided in a side surface of a resin part 13. A recording medium cartridge 2 according to this embodiment is equipped with such an identification part, and is shown in FIG. 13.

The right side of the resin part 13 of the recording medium cartridge 2 is provided with a semicircular recess 13a in parallel to the thickness direction (height direction in the front view of FIG. 1). This makes it possible to visually discriminate between the existing cartridge 1 and the new generation cartridge 2. At the same time, if a cartridge inserting part within a cartridge drive corresponding to the new generation cartridge 2 is provided with a member (or a part) that engages only the identification part of the new generation cartridge 2, it is also possible to prevent incorrect insertion of other recording medium cartridges into this cartridge drive.

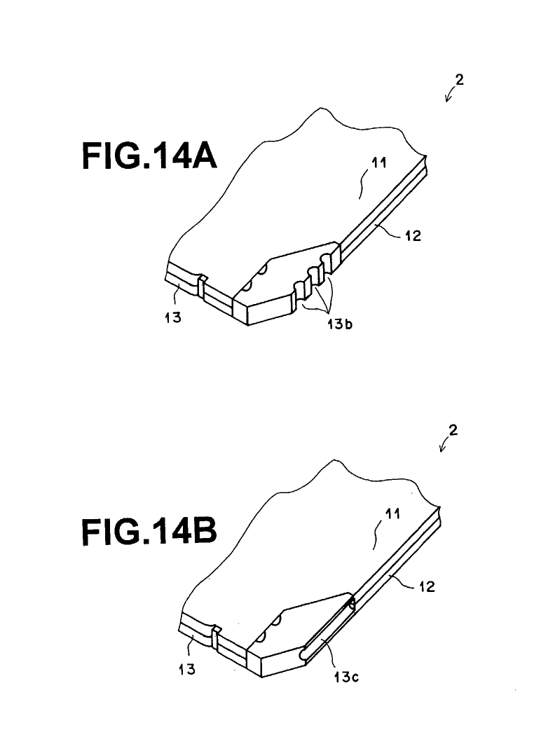

In addition to the aforementioned recess 13a, a plurality of recesses 13b may be provided as shown in FIG. 14A. As shown in FIG. 14B, a recess 13c maybe provided in a direction perpendicular to the thickness direction. The recesses are not limited in number and shape to the aforementioned embodiments. These recesses may be provided in the left side or both sides.

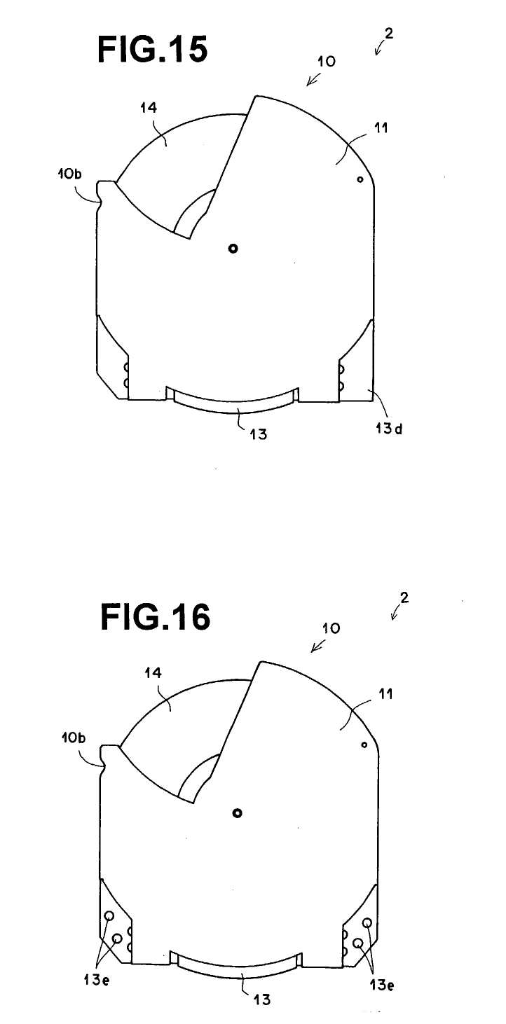

Next, a description will be given of a twenty-second embodiment of the present invention. The identification part in the present invention may be a corner provided the resin part 13 so it differs in shape from that of the existing cartridge 1. A recording medium cartridge 2 according to this embodiment is equipped with such an identification part, and is shown in FIG. 15.

In the figure, the lower right end of the resin part 13 of the recording medium cartridge 2 is provided with an approximately right-angled corner 13d. This makes it possible to visually discriminate between the existing cartridge 1 and the new generation cartridge 2. At the same time, if a cartridge inserting part within a cartridge drive corresponding to the new generation cartridge 2 is provided with a member (or a part) that engages only the identification part of the new generation cartridge 2, it is also possible to prevent incorrect insertion of other recording medium cartridges into this cartridge drive.

In addition to the right-angled corner 13d, the identification part in the present invention may be a round corner. These identification parts may be provided on the left side or both sides.

Next, a description will be given of a twenty-third embodiment of the present invention. The identification part in the present invention may be recesses, which are provided in the top surface or bottom surface of a resin part 13. A recording medium cartridge 2 according to this embodiment is equipped with such an identification part, and is shown in FIG. 16.

The top surface of the resin part 13 of the recording medium cartridge 2 is provided with four recesses 13e. This makes it possible to visually discriminate between the existing cartridge 1 and the new generation cartridge 2. At the same time, if a cartridge inserting part within a cartridge drive corresponding to the new generation cartridge 2 is provided with a member (or a part) that engages only the identification part of the new generation cartridge 2, it is also possible to prevent incorrect insertion of other recording medium cartridges into this cartridge drive.

In addition to the recesses 13e formed in the top surface, the identification part in the present invention may be recesses provided in the bottom surface. The number of recesses also is not to be limited to four.

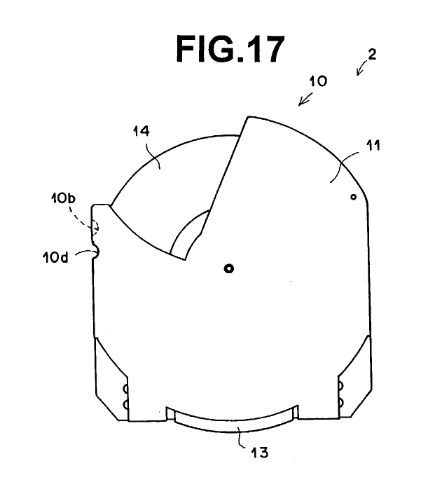

Next, a description will be given of a twenty-fourth embodiment of the present invention. The identification part in the present invention may be a notch provided in a housing side surface so it differs from that of the existing cartridge 1. A recording medium cartridge 2 according to this embodiment is equipped with such an identification part, and is shown in FIG. 17.

In the figure, the left side surface of the housing 10 of the recording medium cartridge 2 is provided with a notch 10d, which is at a position offset downward from the notch 10b of the existing cartridge 1. This makes it possible to visually discriminate between the existing cartridge 1 and the new generation cartridge 2. At the same time, if a cartridge inserting part within a cartridge drive corresponding to the new generation cartridge 2 is provided with a member (or a part) that engages only the identification part of the new generation cartridge 2, it is also possible to prevent incorrect insertion of other recording medium cartridges into this cartridge drive.

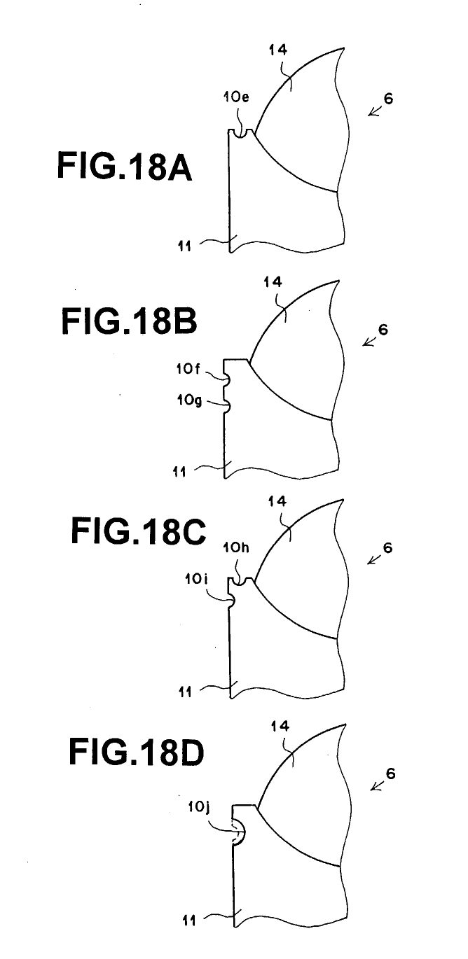

In addition to the notch 10d shown in FIG. 17, the identification part in the present invention may be a notch, which is at a position offset upward from the notch 10b of the existing cartridge 1. As shown in FIG. 18A, it may be provided in the left shoulder portion. As shown in FIG. 18B, two notches 10f and 10g may be provided in the left side surface of the housing 10. As shown in FIG. 18C, a side notch 10i and an upper notch 10h may be provided in the left side surface and left shoulder portion of the housing 10. As shown in FIG. 18D, a notch 10j larger than the current notch 10b may be provided in the side surface. That is, the identification part in the present invention may be any type of notch if it differs from that of the existing cartridge 1.

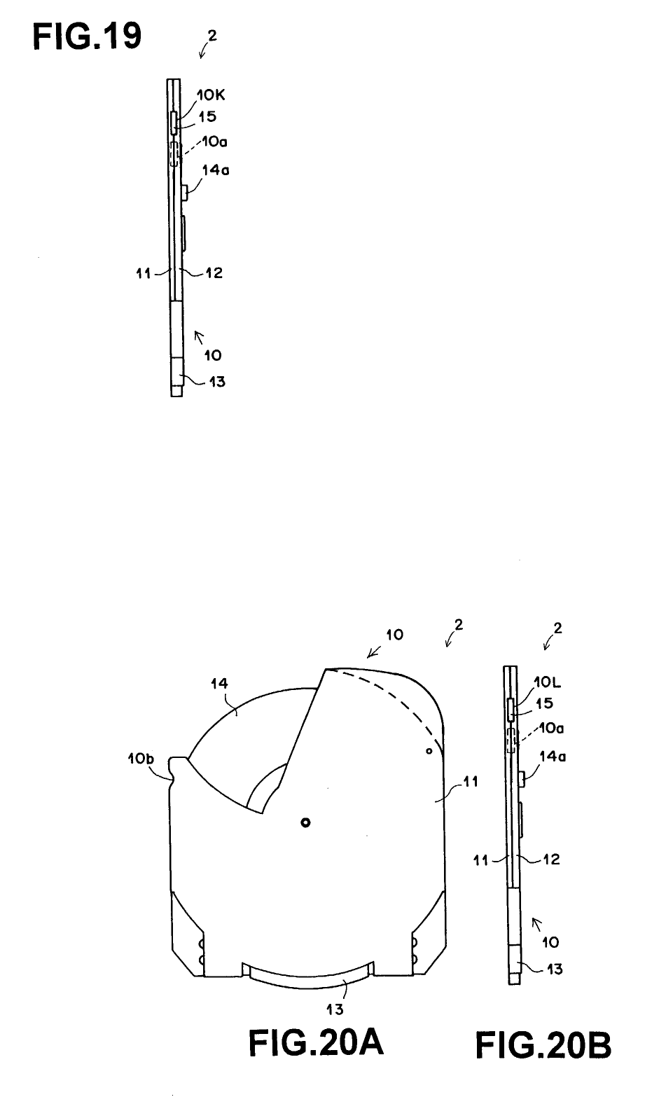

Next, a description will be given of a twenty-fifth embodiment of the present invention. The identification part in the present invention may be a shutter releasing hole provided in a housing side surface, which differs in position from that of the existing cartridge 1. A recording medium cartridge 2 according to this embodiment is equipped with such an identification part, and is shown in FIG. 19.

In the figure, the right side surface of the housing 10 of the new generation cartridge 2 is provided with a hole 10K, which is provided at a position offset upward from the shutter slot 10a of the existing cartridge 1. This makes it possible to visually discriminate between the existing cartridge 1 and the new generation cartridge 2. At the same time, if a cartridge inserting part within a cartridge drive corresponding to this cartridge 2 is provided with a press member (or a part) at a position corresponding to the hole 10K of the new generation cartridge 2, it is also possible to prevent incorrect insertion of other recording medium cartridges into this cartridge drive.

In addition to the hole 10K, the identification part in the present invention may be a hole provided at a position offset downward from the shutter slot 10a of the existing cartridge 1. As shown in FIGS. 20A and 20B, the right shoulder portion may be deformed and provided with a hole 10L. That is, the identification part in the present invention may be any type of hole if it differs from the shutter slot 10a of the existing cartridge 1.

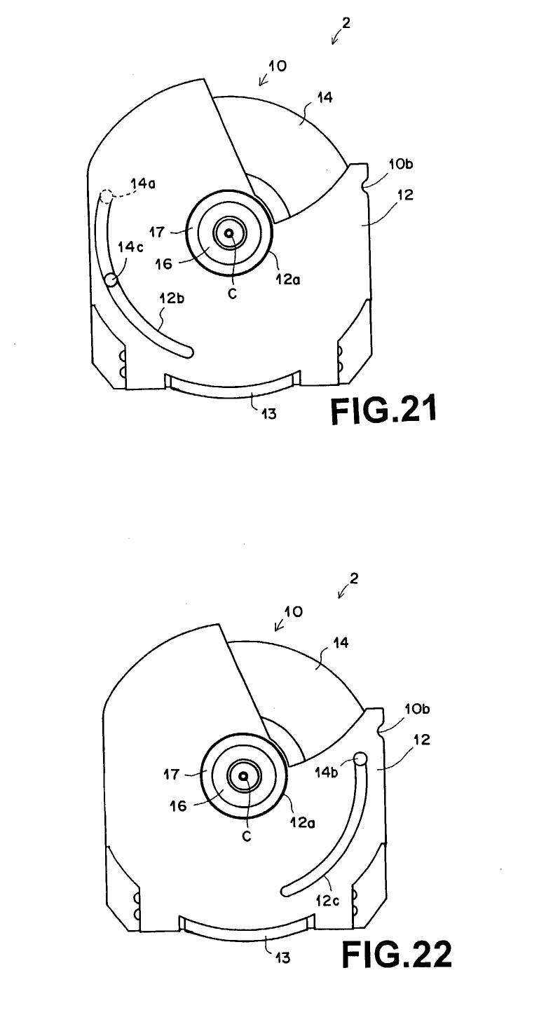

Next, a description will be given of a twenty-sixth embodiment of the present invention. The identification part in the present invention may be a shutter knob provided on a shutter member, different in position from that of the existing cartridge 1. A recording medium cartridge 2 according to this embodiment is equipped with such an identification part, and is shown in FIG. 21.

In the figure, the shutter knob 14b of the new generation cartridge 2 is provided on the right side with respect to the housing center C. A shutter-knob hole 12c also is provided on the right side so the shutter knob 14b is movable. In this cartridge 2, if the shutter member 14 is rotated to a shutter opening position in the right direction with respect to the center C, a magnetic disk 17 is exposed. This makes it possible to visually discriminate between the existing cartridge 1 and the new generation cartridge 2. At the same time, if a cartridge inserting part within a cartridge drive corresponding to this cartridge 2 is provided with a lock member that locks the shutter knob 14b at a position corresponding to the shutter knob 14b, it is also possible to prevent incorrect insertion of other recording medium cartridges into this cartridge drive.

In addition to the shutter knob 14b, the identification part in the present invention may be a shutter knob 14C provided at a position offset downward from the shutter knob 14a of the existing cartridge 1, as shown in FIG. 22. That is, the identification part in the present invention may be any type of shutter knob if it differs from the shutter knob 14a of the existing cartridge 1.

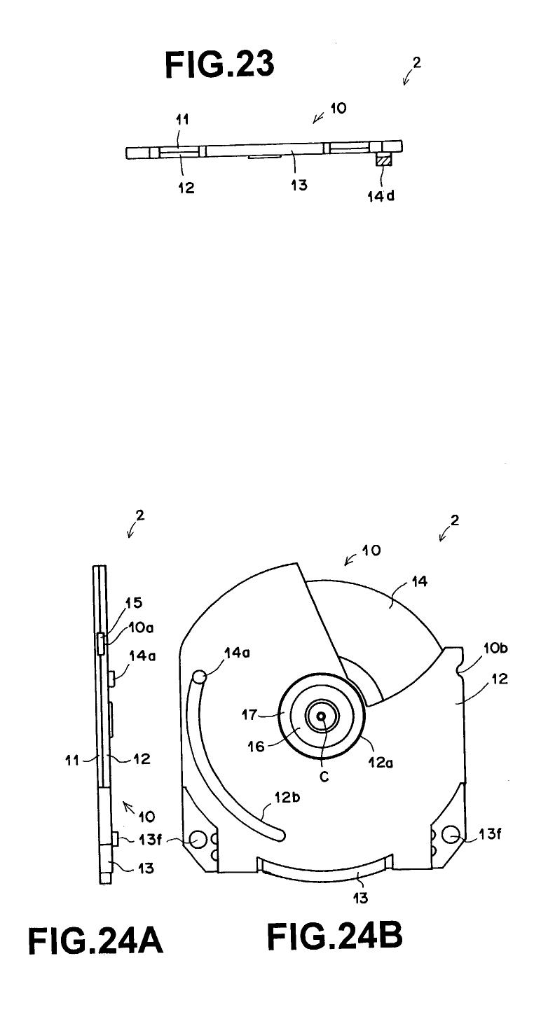

Next, a description will be given of a twenty-seventh embodiment of the present invention. The identification part in the present invention may be a shutter knob provided on a shutter member, different in height from that of the existing cartridge 1. A recording medium cartridge 2 according to this embodiment is equipped with such an identification part, and is shown in FIG. 23.

The shutter knob 14d of the new generation cartridge 2 is formed so it becomes higher than the shutter knob 14a of the existing cartridge 1. (The portion higher than the shutter knob 14a is indicated by hatching.) This makes it possible to visually discriminate between the existing cartridge 1 and the new generation cartridge 2. At the same time, if a cartridge inserting part within a cartridge drive corresponding to this cartridge 2 is provided with a lock member that locks the shutter knob 14d at a position corresponding to the higher portion of the shutter knob 14b than the shutter knob 14a of the existing cartridge 1, it is also possible to prevent incorrect insertion of other recording medium cartridges into this cartridge drive.

Next, a description will be given of a twenty-eighth embodiment of the present invention. The identification part in the present invention maybe legs provided on a housing bottom surface. A recording medium cartridge 2 according to this embodiment is equipped with such an identification part, and is shown in FIGS. 24A and 24B.

In FIG. 24B, the lower opposite ends of the bottom surface of the new generation cartridge 2 are provided with two legs 13f circular in cross-section, which are approximately equal to the height of the shutter knob 14a. This makes it possible to visually discriminate between the existing cartridge 1 and the new generation cartridge 2. At the same time, this embodiment is capable of preventing incorrect insertion into an incompatible cartridge drive that is not equipped with a member (or a part) that engages the identification part of the new generation cartridge 2.

The bottom surface has the two legs 13f. Therefore, when the bottom surface of the new generation cartridge 2 is put on a flat surface such as a desk, it contacts at three points, the shutter knob 14a and the two legs 13f, so it can be stably placed.

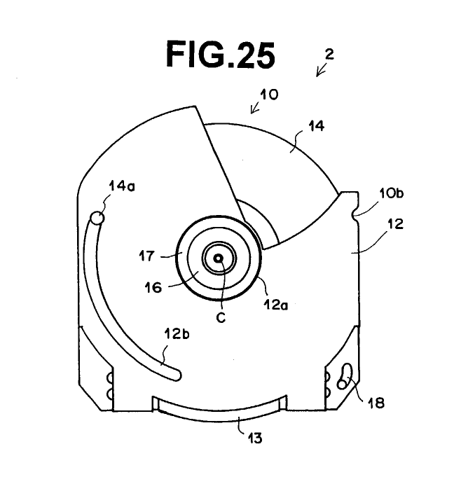

Next, a description will be given of a twenty-ninth embodiment of the present invention. The identification part in the present invention may be a write protect switch provided in a housing bottom surface. A recording medium cartridge 2 according to this embodiment is equipped with such an identification part, and is shown in FIG. 25.

In the figure, the lower right end portion of the bottom surface of the new generation cartridge 2 is provided with a write protect switch 18. This makes it possible to visually discriminate between the existing cartridge 1 and the new generation cartridge 2. If a cartridge drive corresponding to this cartridge 2 has the function of protecting data recorded on a magnetic disk 17 according to the position of the write protect switch 18, the recorded data can be protected.

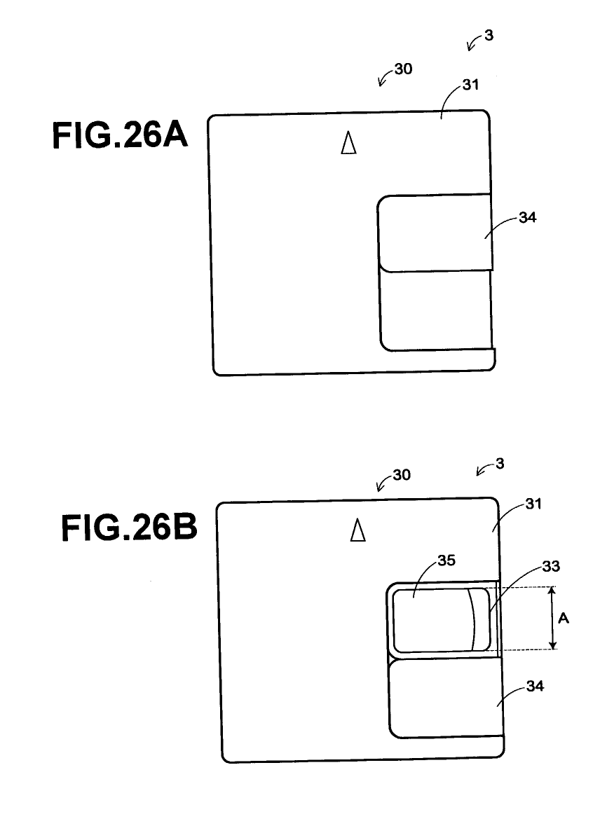

Next, a description will be given of a thirtieth embodiment and a thirty-first embodiment of the present invention. In these embodiments, the present invention is applied to MD cartridges. Initially, a description will be given of currently existing MD cartridges (hereinafter referred to as existing cartridges). In FIG. 26A the shutter member of the existing cartridge 3 is held at a shutter closing position, and in FIG. 26B the shutter member is held at a shutter opening position.

The existing cartridge (MD cartridge) 3 has a thin, flat housing 30, within which a magneto-optical (MO) disk 35 firmly attached to a center hub is rotatably accommodated.

The housing 30 is constructed of upper and lower shell halves 31 and 32 fastened together. Upper and lower head holes 33 are formed at corresponding positions of the upper and lower shell halves 31 and 32, and read-write heads are positioned over both sides of the magneto-optical disk 35 through the upper and lower head holes 33. In FIGS. 26A and 26B, a shutter member 34 is slidable in the vertical direction so both sides of the magneto-optical disk 35 are exposed through the upper and lower head holes 33. The shutter member 34 is formed into a U shape by a pair of upper and lower flat plate portions that extend along the upper and lower shell halves 31 and 32, and a vertical plate portion that connects the upper and lower flat plate portions together.

In the case where a new generation cartridge is made based on the existing cartridge 3 with the head holes 33 provided in the housing 30, the identification part in the present invention may be a head hole provided so it differs from that of the existing cartridge 3. Recording medium cartridges according to the thirtieth and thirty-first embodiments of the present invention are equipped with such an identification part.

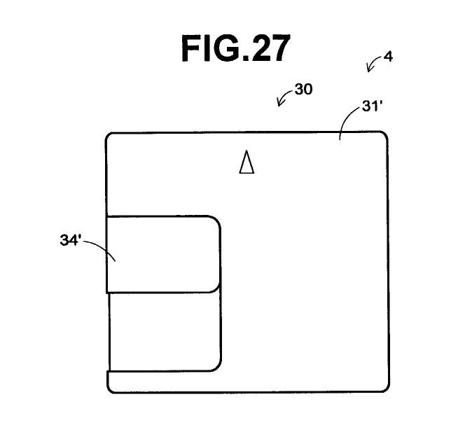

As an example of a head hole provided so it differs from that of the existing cartridge 3, the head hole 33 and shutter member 34 of a new generation cartridge 4, which are conventionally disposed on the right side of the existing cartridge 3, may be disposed on the left side, as shown in FIG. 27 as the thirtieth embodiment of the present invention. This makes it possible to visually discriminate between the existing cartridge 3 and the new generation cartridge 4. In addition, insertion into an incompatible cartridge drive (such as a cartridge drive for the existing cartridge 3 in which the position of the read-write head does not correspond to that of the head hole of the new generation cartridge 4) becomes physically impossible, so it is also possible to prevent incorrect insertion into such an incompatible cartridge drive.

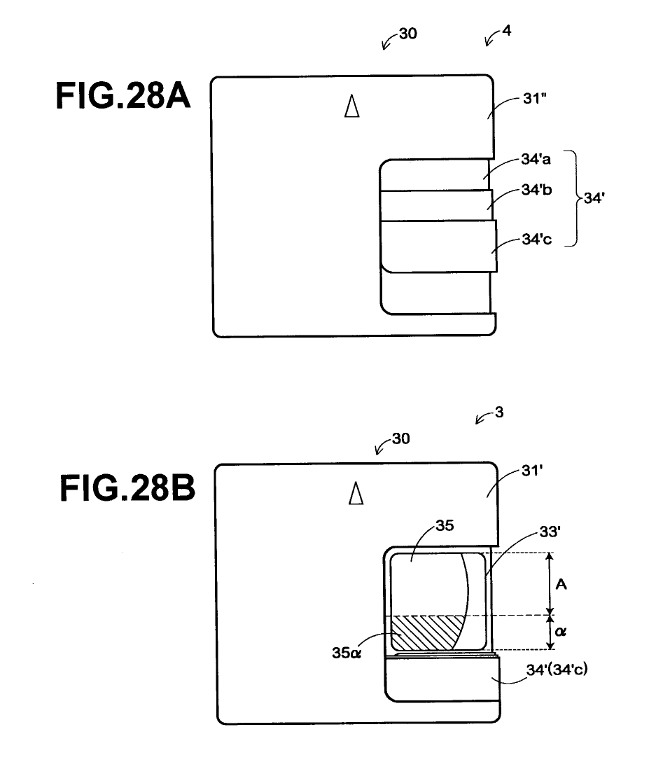

As another example of the head hole provided so it differs from that of the existing cartridge 3, the size of a head hole 33′ of a new generation cartridge 4 may be made larger than that of the existing cartridge 3, as shown in FIG. 28 as the thirty-first embodiment of the present invention. If a shutter member is made according to the size of the head hole 33′, there is a possibility that an ordinary shutter member cannot be used. In that case, a shutter member 34′ can be made from a plurality of shutters, as described in Japanese Patent Application No. 2001-375864, for example. This makes it possible to visually discriminate between the existing cartridge 3 and the new generation cartridge 4. In a cartridge drive for the new generation cartridge 4, if a read-write head is disposed at a position corresponding to a head hole 35a (indicated by hatching) that is not shared with the existing cartridge 3, the reading/writing of data with respect to the existing cartridge 3 can be limited. Note that the size of the head hole 33′ may be smaller than that of the existing cartridge 3.

Next, a description will be given of a thirty-second embodiment to a thirty-fourth embodiment of the present invention. The identification part in the present invention may be a housing that differs in size from that of the existing cartridge. Recording medium cartridges according to these embodiments are equipped with such an identification part.

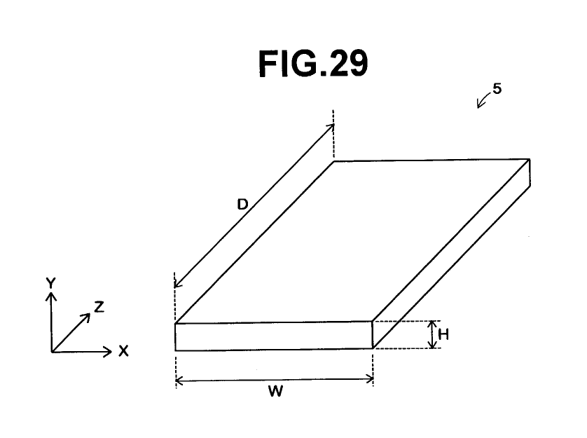

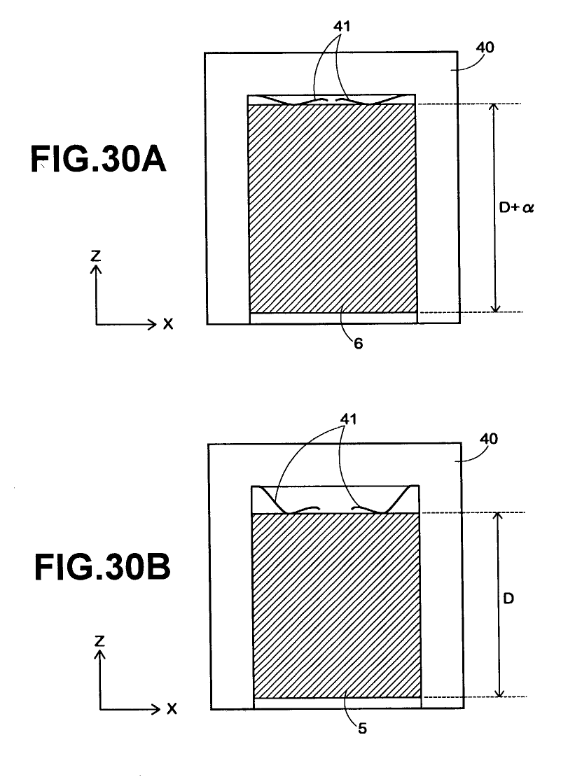

As shown in FIG. 29, suppose that the existing cartridge 5 has a size of width W×height H×depth D. As an example of a housing differing in size from that of the existing cartridge 5, the depth of a new generation cartridge 6 may be changed from D to D+α, as shown in FIG. 30A as the thirty-second embodiment of the present invention. This makes it possible to visually discriminate between the existing cartridge 5 and the new generation cartridge 6. In addition, insertion into an incompatible cartridge drive (such as a cartridge drive for the existing cartridge 5 in which the size of the cartridge inserting part does not correspond to that of the new generation cartridge 6) becomes physically impossible, so it is also possible to prevent incorrect insertion into such an incompatible cartridge drive. As shown in FIG. 30A, if an elastic member 41 for urging an inserted cartridge in a direction opposite to the insertion direction of the cartridge is provided within the cartridge inserting part of a cartridge drive 40 for the new generation cartridge 6, chatter of the inserted cartridge against the cartridge inserting part can be eliminated even when a cartridge with a housing having a different depth than that of the new generation cartridge 6 is inserted. This renders it possible for the cartridge drive 40 of the new generation cartridge 6 to have upward compatibility.

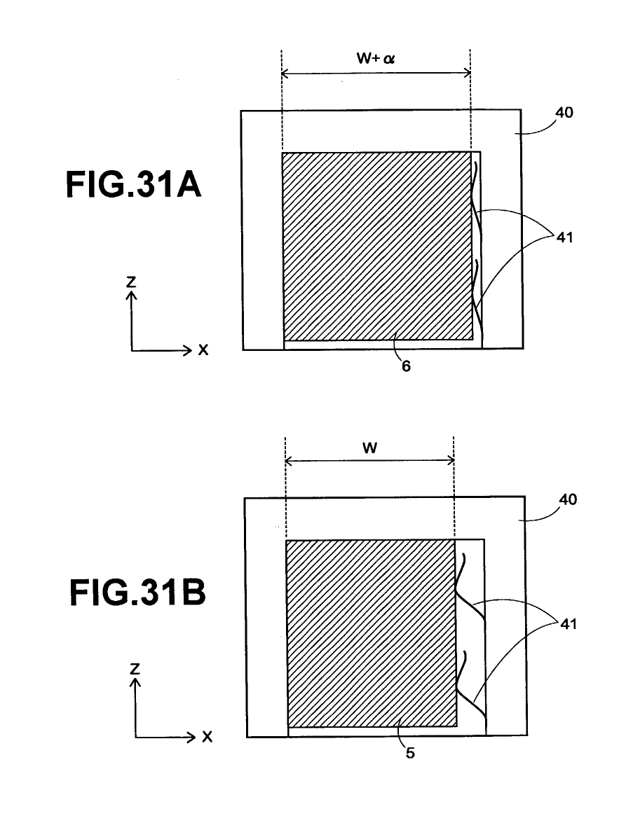

As shown in FIG. 31A as the thirty-third embodiment of the present invention, the width of a new generation cartridge 6 may be changed from W to W+α. This makes it possible to visually discriminate between the existing cartridge 5 and the new generation cartridge 6. In addition, insertion into an incompatible cartridge drive (such as a cartridge drive for the existing cartridge 5 in which the size of the cartridge inserting part does not correspond to that of the new generation cartridge 6) becomes physically impossible, so it is also possible to prevent incorrect insertion into such an incompatible cartridge drive. As shown in FIG. 31A, if an elastic member 41 for urging an inserted cartridge from the side toward the center is provided within the cartridge inserting part of a cartridge drive 40 for the new generation cartridge 6, chatter of the inserted cartridge against the cartridge inserting part can be eliminated even when a cartridge with a housing having a different width than that of the new generation cartridge 6 is inserted. This renders it possible for the cartridge drive 40 of the new generation cartridge 6 to have upward compatibility.

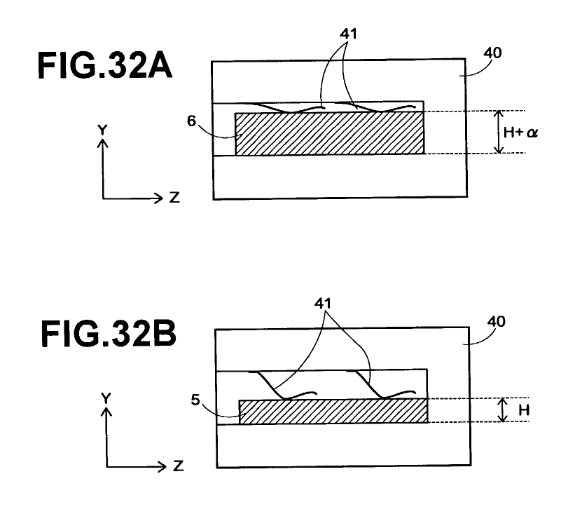

As shown in FIG. 32A as the thirty-fourth embodiment of the present invention, the height of a new generation cartridge 6 may be changed from H to H+α. This makes it possible to visually discriminate between the existing cartridge 5 and the new generation cartridge 6. In addition, insertion into an incompatible cartridge drive (such as a cartridge drive for the existing cartridge 5 in which the size of the cartridge inserting part does not correspond to that of the new generation cartridge 6) becomes physically impossible, so it is also possible to prevent incorrect insertion into such an incompatible cartridge drive. As shown in FIG. 32A, if an elastic member 41 for urging an inserted cartridge from the top surface toward the bottom surface is provided within the cartridge inserting part of a cartridge drive 40 for the new generation cartridge 6, chatter of the inserted cartridge against the cartridge inserting part can be eliminated even when a cartridge with a housing having a different height from that of the new generation cartridge 6 is inserted. This renders it possible for the cartridge drive 40 of the new generation cartridge 6 to have upward compatibility.

While the depth, width, and height of the housing are changed separately in the aforementioned embodiments, they may be combined as desires to change the size of the housing.

Although the present invention has been described with reference to the preferred embodiments thereof, the invention is not to be limited to the aforementioned “clik!™” and MD cartridge, but may be applied to any type of recording medium cartridge.

What is claimed is:

1. A recording medium cartridge comprising:
a disk medium;
a housing for accommodating said medium, provided with a head hole through which a read/write head of a cartridge drive unit accesses said medium; and
a slidable shutter that is opened or closed in said head hole;
wherein recording medium cartridges of different generations can be constituted by accommodating a different recording medium with a different recording capacity within said housing of approximately the same shape;
and wherein an external surface of said housing has an identification part for identifying said recording capacity.

2. The recording medium cartridge as set forth in claim 1, wherein said identification part comprises a protrusion or protrusions provided on either or both of side surfaces of said housing.

3. The recording medium cartridge as set forth in claim 2, wherein said protrusions are provided one by one on both side surfaces of said housing.

4. The recording medium cartridge as set forth in claim 3, wherein said protrusions provided one by one on both side surfaces of said housing are provided at the same position with respect to a direction in which said cartridge is inserted.

5. The recording medium cartridge as set forth in claim 3, wherein said protrusions provided one by one on both side surfaces of said housing are provided at different positions with respect to a direction in which said cartridge is inserted.

6. The recording medium cartridge as set forth in claim 3, wherein said housing has a resin part.

7. The recording medium cartridge as set forth in claim 6, wherein said protrusion is provided on a side surface of said resin part.

8. The recording medium cartridge as set forth in claim 6, wherein
said resin part extends between both side surfaces of said housing; and
said protrusions are provided on both side surfaces of said resin part.

9. The recording medium cartridge as set forth in claim 2, wherein said protrusion is approximately semicircular in cross section.

10. The recording medium cartridge as set forth in claim 2, wherein said protrusion is approximately triangular in cross section.

11. The recording medium cartridge as set forth in claim 1, wherein said identification part comprises a protrusion or protrusions provided on either or both of the top and bottom surfaces of said housing.

12. The recording medium cartridge as set forth in claim 11, wherein at least one protrusion is provided on each of the top and bottom surfaces of said housing.

13. The recording medium cartridge as set forth in claim 12, wherein the protrusion provided on the top surface of said housing differs in width from that provided on the bottom surface of said housing.

14. The recording medium cartridge as set forth in claim 12, wherein
the protrusion provided on one of the top and bottom surfaces of said housing is approximately arcuate in cross section; and
the protrusion provided on the other of the top and bottom surfaces of said housing is approximately triangular in cross section.

15. The recording medium cartridge as set forth in claim 14, wherein said approximately triangular cross-section protrusion comprises a plurality of approximately triangular cross-section protrusions.

16. The recording medium cartridge as set forth in claim 12, wherein the protrusions provided on the top and bottom surfaces of said housing are provided at different positions on the top and bottom surfaces of said housing.

17. The recording medium cartridge as set forth in claim 12, wherein
the protrusions provided either or both of the top and bottom surfaces of said housing are provided at three places, approximately the center portion and approximately both side portions of said housing, in a direction perpendicular to a direction where the cartridge is inserted.

18. The recording medium cartridge as set forth in claim 1, wherein said identification comprises a recess provided in a direction opposite to a direction where the cartridge is inserted.

19. The recording medium cartridge as set forth in claim 18, wherein
said housing has a resin part in a direction opposite to the direction where the cartridge is inserted; and
said recess is provided in said resin part.

20. The recording medium cartridge as set forth in claim 1, wherein said identification part comprises a recess or recesses provided in either or both of side surfaces of said housing.

21. The recording medium cartridge as set forth in claim 20, wherein said recess comprises a notch provided in the vertical direction of said housing.

22. The recording medium cartridge as set forth in claim 21, wherein
said housing has a resin part;
said recess is approximately semicircular in shape; and
said recess comprises three recesses provided in said resin part.

23. The recording medium cartridge as set forth in claim 20, wherein said recess comprises a notch provided along a direction in which said cartridge is inserted.

24. The recording medium cartridge as set forth in claim 23, wherein
said housing has a resin part; and
said recess is provided in said resin part.

25. The recording medium cartridge as set forth in claim 1, wherein said identification part comprises a hole that engages an engagement member of said cartridge drive unit.

26. The recording medium cartridge as set forth in claim 25, wherein
said housing has a resin part; and
said hole is provided in said resin part.

27. The recording medium cartridge as set forth in claim 1, wherein
a front corner of the top and bottom surfaces of said housing in an insertion direction is arcuate in shape;
said housing has a shutter lock for locking said shutter at a closing position, and a shutter slot through which said shutter lock is exposed; and
the entire shutter slot is provided in said front corner of said housing.
